(19) United States
(12) Patent Application Publication
(10) Pub. No.: US 2025/0133577 A1
(43) Pub. Date: Apr. 24, 2025

(54) METHODS AND APPARATUSES FOR SIDELINK POSITIONING

(71) Applicant: LENOVO (BEIJING) LIMITED, Beijing (CN)

(72) Inventors: Jie HU, Beijing (CN); Jing HAN, Beijing (CN); Lianhai WU, Beijing (CN); Ran YUE, Beijing (CN); Min XU, Beijing (CN)

(21) Appl. No.: 18/722,092

(22) PCT Filed: Dec. 21, 2021
(86) PCT No.: PCT/CN2021/140175

§ 371 Date: Jun. 20, 2024

(51) Int. Cl. H04W 72/25; H04W 64/00

(52) U.S. Cl. CPC H04W 72/25; H04W 64/00

(57) ABSTRACT

Embodiments of the present disclosure relate to methods and apparatuses for sidelink (SL) positioning. According to an embodiment of the present disclosure, a first user equipment (UE) can include: a transmitter configured to transmit first assistance information to a network, wherein the first assistance information includes UE information associated with at least one second UE, and wherein the at least one second UE helps the first UE to acquire its position; a receiver configured to receive first SL positioning related information from the network; and a processor coupled to the transmitter and the receiver.

### TECHNICAL FIELD

Embodiments of the present application generally relate to wireless communication technology, and especially to methods and apparatuses for sidelink (SL) positioning.

### BACKGROUND

SL positioning refers to transmitting positioning reference signal (PRS) over SL, which can operate independently of network or radio access technology (RAT) coverage and provide a new positioning method that fits new network use cases, such as vehicle-to-everything (V2X), public safety, commercial, industrial internet of things (IIOT), etc.

Service requirements for SL positioning have been defined in corresponding specification. Based on the specified requirements, solutions for SL positioning need be studied to support “both in coverage,” “partial coverage” and “both out of coverage” scenarios. Currently, details regarding the positioning architecture and signaling procedures for the SL positioning have not been discussed in 3GPP 5G and/or NR technology yet.

### SUMMARY OF THE APPLICATION

Embodiments of the present application at least provide technical solutions for SL positioning.

According to some embodiments of the present application, a method performed by a first UE may include: transmitting first assistance information to a network, wherein the first assistance information includes UE information associated with at least one second UE, and wherein the at least one second UE helps the first UE to acquire its position; and receiving first SL positioning related information from the network.

In some embodiments of the present application, the first assistance information further includes at least one of: location service requirement(s) associated with the first UE; configuration parameter(s) requested by the first UE from the network; or schedule location time of the first UE.

In some embodiments of the present application, the at least one second UE is determined by the first UE, and the UE information includes at least one of: an identification of each of the at least one second UE; the number of second UE(s); a status of each of the at least one second UE; serving cell information of each of the at least one second UE; UE capability associated with SL positioning of each of the at least one second UE; or a candidate UE list including an index of each of the at least one second UE.

In some embodiments of the present application, the at least one second UE is determined by the network based on the UE information, and the UE information includes at least one of: a minimum number of second UEs helping the first UE to acquire its position; or a preferred UE type of each of the second UEs helping the first UE to acquire its position.

In some embodiments of the present application, the method may further include: transmitting the first assistance information to the network in response to at least one of the following conditions: measurement quality for SL positioning meets a threshold; or current SL positioning configuration cannot satisfy quality of service (QOS) requirement(s).

In some embodiments of the present application, the method may further include: transmitting the first assistance information to a location management function (LMF) via a long term evolution (LTE) positioning protocol (LPP) signaling or to a serving base station (BS) via a radio resource control (RRC) signaling.

In some embodiments of the present application, the first SL positioning related information includes at least one mapping, and wherein each mapping is: a mapping between a SL positioning configuration and a corresponding sidelink destination ID; a mapping between a SL positioning configuration and a corresponding second UE of the at least one second UE; or a mapping between a SL positioning configuration and a corresponding SL positioning capability index.

In some embodiments of the present application, the SL positioning configuration includes at least one of: information for transmitting or receiving SL positioning reference signal (SL-PRS); information for measuring the SL-PRS; or information for reporting a measurement result of the SL-PRS.

In some embodiments of the present application, the method may further include: receiving the first SL positioning related information from a LMF via an LPP signaling or from a serving BS via an RRC signaling.

In some embodiments of the present application, the method may further include: transmitting SL positioning configuration information to a second UE of the at least second UE, and wherein the receiver is further configured to receive an indication indicating whether the SL positioning configuration information is rejected or accepted by the second UE, wherein the SL positioning configuration information is generated based on the first SL positioning related information and includes a SL positioning configuration or an index associated with the SL positioning configuration.

In some embodiments of the present application, the method may further include: transmitting the received indication to the network.

In some embodiments of the present application, the method may further include: transmitting the SL positioning configuration information to the second UE in response to at least one of the following conditions: the first UE determines the SL positioning configuration; the second UE is determined by the first UE; UE information of the second UE is acquired by the first UE; the SL RRC connection between first UE and second UE are established; or the first UE receives a configuration request from the second UE.

In some embodiments of the present application, the method may further include: receiving second assistance information from the second UE before transmitting the SL positioning configuration information to a second UE.

In some embodiments of the present application, the method may further include: transmitting SL positioning configuration information to the second UE in a RRC message or in an upper layer signaling for SL positioning.

In some embodiments of the present application, wherein a state of the first UE is changed from an in-coverage state to an out-of-coverage state, and the method further includes performing at least one of: keeping using the first SL positioning related information until the first SL positioning related information becomes invalid; acquiring second SL positioning related information in the out-of-coverage state and keeping using the first SL positioning related information in the in-coverage state until the second SL positioning related information is available, wherein the second SL positioning related information is acquired by pre-configuration information; or using default SL positioning related information during a time period from the first SL positioning related information becomes invalid to the second SL positioning related information is available, wherein the default SL positioning related information is pre-defined.

In some embodiments of the present application, the pre-configuration information includes at least one mapping, each mapping of the at least one mapping is one of: a mapping between a SL positioning configuration and a corresponding accuracy requirement; a mapping between a SL positioning configuration and a corresponding number of third UEs, wherein each of the third UE helps the first UE to acquire its position; a mapping between a SL positioning configuration and a corresponding SL positioning method; and a mapping between a SL positioning configuration and a corresponding QoS or a radio condition.

In some embodiments of the present application, the pre-configuration information is pre-configured with a valid condition including at least one of: a valid area for the pre-configuration information; and a valid timer period for the pre-configuration information.

In some embodiments of the present application, wherein a state of the first UE is changed from an out-of-coverage state to an in-coverage state, and the method further includes: reporting third SL positioning related information to the network, wherein the third SL positioning related information includes at least one of: UE information associated with at least one fourth UE, wherein the at least one fourth UE helps the first UE to acquire its position in the out-of-coverage state; SL positioning configuration associated with each of the at least one fourth UE; third assistance information.

In some embodiments of the present application, the method may further include: reporting fourth SL positioning related information used in a source cell to the network after a handover procedure to a target cell is completed, wherein the fourth SL positioning related information is generated based on the first SL positioning related information and includes at least one of: UE information associated with the at least one second UE; and SL positioning configuration associated with the each of at least one second UE; wherein the processor is further configured to keep using the fourth SL positioning related information before receiving a new positioning related information for the target cell from the network.

In some embodiments of the present application, the method may further include: keeping using the fourth SL positioning related information when at least one of the following timers is running: a first timer which is started when receiving an RRC reconfiguration message during the handover procedure; or a second timer which is started when initiating an RRC connection re-establishment procedure.

In some embodiments of the present application, the method may further include: receive new positioning related information for a target cell in a handover command from a source cell, and wherein the processor is further configured to perform at least one of: using the new positioning related information during a handover procedure; or using the new positioning related information after a handover procedure to a target cell is completed.

In some embodiments of the present application, the method may further include: use the new positioning related information when at least one of the following timers is running: a first timer which is started when receiving an RRC reconfiguration message during the handover procedure; or a second timer which is started when initiating an RRC connection re-establishment procedure.

According to some embodiments of the present application, a method performed by a second UE may include: receiving SL positioning configuration information from a first UE; and transmitting an indication indicating whether the SL positioning configuration information is rejected or accepted by the second UE.

In some embodiments of the present application, the method may further include: receiving the SL positioning configuration information in a RRC message or in an upper layer signaling for SL positioning.

In some embodiments of the present application, the SL positioning configuration information includes a SL positioning configuration associated with the second UE or an index associated with the SL positioning configuration, and wherein the SL positioning configuration includes at least one of: information for transmitting or receiving SL-PRS; information for measuring the SL-PRS; or information for reporting a measurement result of the SL-PRS.

In some embodiments of the present application, the method may further include: transmitting assistance information to the first UE before receiving the SL positioning configuration information from the first UE.

In some embodiments of the present application, wherein the assistance information includes at least one of: at least one SL positioning configuration related to at least one third UE; PRS configuration; or sounding reference signal (SRS) configuration.

In some embodiments of the present application, the method may further include: transmitting the SL positioning configuration information to the network in the case that the second UE is in-coverage of the network and determines to use the received SL positioning configuration information.

In some embodiments of the present application, the method may further include: transmitting the SL positioning configuration information to the network in the case that the second UE connects to the network.

In some embodiments of the present application, the method may further include: reporting the SL positioning configuration information to the network after a handover procedure to a target cell is completed.

According to some embodiments of the present application, a method performed by a network entity may include: receiving assistance information from a first UE, wherein the assistance information includes UE information associated with at least one second UE, and wherein the at least one second UE helps the first UE to acquire its position; and transmitting SL positioning related information to the first UE.

In some embodiments of the present application, the assistance information further includes at least one of: location service requirement(s) associated with the first UE; configuration parameter(s) requested by the first UE from the network; or schedule location time of the first UE.

In some embodiments of the present application, the at least one second UE is determined by the first UE, and the UE information includes at least one of: an identification of each of the at least one second UE; the number of second UE(s); a status of each of the at least one second UE; serving cell information of each of the at least one second UE; UE capability associated with SL positioning of each of the at least one second UE; or a candidate UE list including an index of each of the at least one second UE.

In some embodiments of the present application, the at least one second UE is determined by the network based on the UE information, and the UE information includes at least one of: a minimum number of second UEs helping the first UE to acquire its position; or a preferred UE type of each of the second UEs helping the first UE to acquire its position.

In some embodiments of the present application, the method may further include: receive the assistance information via an LPP signaling or an RRC signaling.

In some embodiments of the present application, the SL positioning related information includes at least one mapping, and wherein each mapping is: a mapping between a SL positioning configuration and a corresponding sidelink destination ID; a mapping between a SL positioning configuration and a corresponding second UE of the at least one second UE; or a mapping between a SL positioning configuration and a corresponding SL positioning capability index.

In some embodiments of the present application, the SL positioning configuration includes at least one of: information for transmitting or receiving SL-PRS; information for measuring the SL-PRS; or information for reporting a measurement result of the SL-PRS.

In some embodiments of the present application, the method may further include: transmitting the SL positioning related information via an LPP signaling or an RRC signaling.

In some embodiments of the present application, the method may further include performing at least one of: transmitting the SL positioning related information in a handover request of a handover procedure to target cell of the first UE; or transmitting an indication in the handover request to the target cell, wherein the indication indicates the target cell that the SL positioning related information is kept being used by the first UE during the handover procedure until the first UE connects to the target cell and acquires new SL positioning related information from target cell.

In some embodiments of the present application, the method may further include: transmitting new SL positioning related information obtained from the target cell to a LMF after deciding to perform a handover execution.

According to some embodiments of the present application, a first UE may include: a transmitter configured to transmit first assistance information to a network, wherein the first assistance information includes UE information associated with at least one second UE, and wherein the at least one second UE helps the first UE to acquire its position; a receiver configured to receive first SL positioning related information from the network; and a processor coupled to the transmitter and the receiver.

According to some embodiments of the present application, a second UE may include: a receiver configured to receive SL positioning configuration information from a first UE; a transmitter configured to transmit an indication indicating whether the SL positioning configuration information is rejected or accepted by the second UE; and a processor coupled to the transmitter and the receiver.

According to some embodiments of the present application, a network entity may include: a receiver configured to receive assistance information from a first UE, wherein the assistance information includes UE information associated with at least one second UE, and wherein the at least one second UE helps the first UE to acquire its position; a transmitter configured to transmit SL positioning related information to the first UE; and a processor coupled to the transmitter and the receiver.

Embodiments of the present application provide technical solutions for SL positioning, which include but are not limited to apparatuses and methods for the positioning architecture and signaling procedures for the SL positioning.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary Uu positioning procedure according to some embodiments of the present application;

FIGS. 3A-3D illustrates four exemplary SL positioning architectures according to some embodiments of the present application;

FIG. 4 is a flow chart illustrating an exemplary method for SL positioning according to some embodiments of the present application;

FIG. 5 is a flow chart illustrating an exemplary method for SL positioning according to some other embodiments of the present application;

FIG. 6 is a flow chart illustrating an exemplary method for SL positioning according to some other embodiments of the present application; and

FIG. 7 illustrates a simplified block diagram of an exemplary apparatus for SL positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., new radio (NR)), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

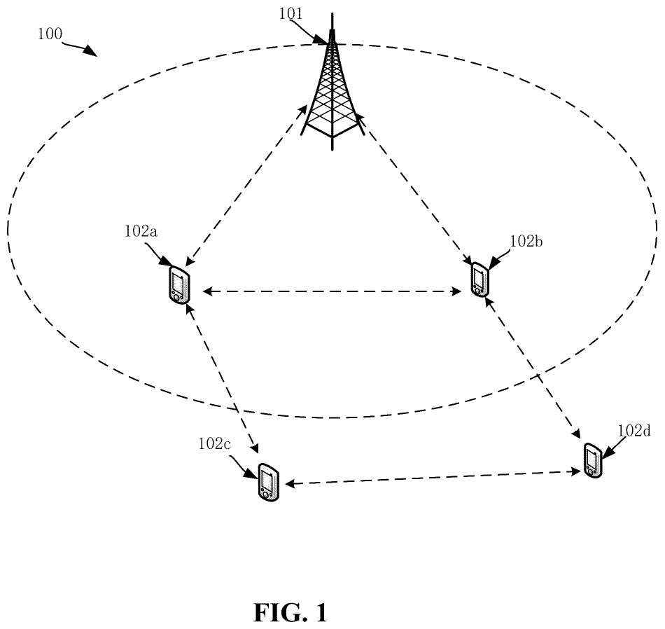

FIG. 1 is a schematic diagram illustrating an exemplary wireless communication system 100 according to some embodiments of the present application.

As shown in FIG. 1, the wireless communication system 100 includes at least one base station (BS) 101 and at least one UE (e.g., a UE 102a, a UE 102b, a UE 102c, and a UE 102d). Although one BS and four UEs are depicted in FIG. 1 for illustrative purpose, it is contemplated that any number of BSs and UEs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

According to some embodiments of the present application, the UE 102a, the UE 102b, the UE 102c, and the UE 102d may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a, the UE 102b, the UE 102c, and the UE 102d may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a, the UE 102b, the UE 102c, and the UE 102d may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a, the UE 102b, the UE 102c, and the UE 102d may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The UE 102c and the UE 102d are outside the coverage area of the BS 101. The UE 102a may communicate with the UE 102b and the UE 102c via SL (for example, via PC5 interface as defined in 3GPP standard documents), and the UE 102d may communicate with the UE 102b and the UE 102c via SL.

When a location service request is initiated or occurs at a UE, the UE (referred to as target UE or location service (LCS) target UE) needs to know its own position. When the target UE is within a coverage area of a BS or network (i.e., in coverage), the target UE may get positioning information from the BS or network, which is known as Uu positioning or NR Uu positioning. When the target UE is outside a coverage area of any BS or network (i.e., out of coverage), the target UE cannot get positioning information from any BS or network. According to various embodiments of the present disclosure, regardless of in coverage or out of coverage, the target UE (also referred to as SL target UE) may select one or more other UEs to be anchor UE(s) (also referred to as SL anchor UE(s)), which may participate in SL positioning and help the SL target UE to acquire its position, e.g., by sending/receiving SL PRS and doing relevant measurements. According to some other embodiments of the present application, the anchor UE(s) may be determined by the network (e.g., by the LMF or a BS) instead of being selected by the target UE. In such embodiment, the target UE and the anchor UE(s) may be in coverage of the network. The SL anchor UE should have positioning capability, and may be a roadside unit (RSU) or any SL UE.

When performing SL positioning, the SL target UE and the SL anchor UE may be both in coverage (i.e., “both in coverage” scenario), or one in coverage and the other out of coverage (i.e., “partial coverage” scenario), or both out of coverage (i.e., “both out of coverage” scenario).

In an embodiment, the UE 102a may act as an SL target UE. The UE 102a may select the UE 102b to be an SL anchor UE to assist the UE 102a to acquire its position, which is in the “both in coverage” scenario. Alternatively or additionally, the UE 102a may select the UE 102c to be an SL anchor UE to assist the UE 102a to acquire its position, which is in the “partial coverage” scenario. It should be understood that the UE 102a may alternatively or additionally select other SL anchor UE(s) not shown in FIG. 1.

In an embodiment, the UE 102d may act as an SL target UE. The UE 102d may select the UE 102b to be an SL anchor UE to assist the UE 102d to acquire its position, which is in the “partial coverage” scenario. Alternatively or additionally, the UE 102d may select the UE 102c to be an SL anchor UE to assist the UE 102d to acquire its position, which is in the “both out of coverage” scenario. It should be understood that the UE 102d may alternatively or additionally select other SL anchor UE(s) not shown in FIG. 1. The SL anchor UE(s) selected by the UE 102d may be different from the SL anchor UE(s) selected by the UE 102a.

In the “both in-coverage” scenario and “partial coverage” scenario, the NR Uu positioning, the NR SL positioning, or the RAT-independent positioning can be applied for a UE to support different location service requests. The NR Uu positioning may include RAT-dependent positioning. The RAT-dependent positioning may mean that the UE's position is calculated based on reference signal (e.g., SRS, PRS, and/or other reference signal) measurement(s) in Uu interface. The RAT-independent positioning may mean that the positioning is not related to the reference signal(s) in Uu interface (e.g., wireless local area network (WLAN) positioning, Bluetooth positioning, global navigation satellite system (GNSS) positioning, etc.). Since the location services and UE positioning capabilities are various, the applicable positioning methods for a UE may be changed due to some external conditions, and thus the corresponding initiation conditions for a positioning method and abort conditions for a positioning method need to be defined.

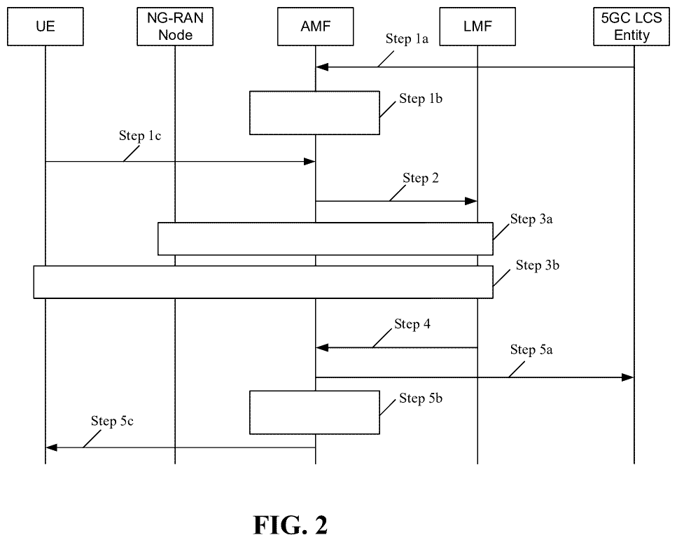

In the NR Uu positioning procedure, a UE and an LMF may coordinate positioning related information by LTE positioning protocol (LPP) signaling. FIG. 2 illustrates an exemplary Uu positioning procedure according to some embodiments of the present application.

The UE is assumed to be in connected mode before the beginning of the flow shown in the FIG. 2. That is, any signaling that may be required to bring the UE to connected mode prior to step 1a as shown in FIG. 2.

Referring to FIG. 2, in step 1a, a 5G core network (5GC) LCS entity (e.g., gateway mobile location center (GMLC)) may transmit a location service request to a access and mobility management function (AMF) serving a UE to request one or more location services (e.g. a positioning service) for the UE, which is also referred to as a target UE. The one or more location services may need to know the position of the UE.

Alternatively or additionally, in step 1b, the AMF serving the UE may determine the need for one or more location services (e.g., to locate the UE for an emergency call) and generate a location service request.

Alternatively or additionally, in step 1c, the UE may transmit a location service request to the serving AMF at a non-access-stratum (NAS) level to request one or more location services (e.g., positioning service or delivery of assistance data).

In step 2, the AMF may transfer the location service request to an LMF.

In step 3a, the LMF may instigate location procedure(s) with the serving next generation radio access network (NG-RAN) node (e.g., ng-eNB or gNB) and possibly neighboring NG-RAN node(s), e.g., to obtain positioning measurement(s) or assistance data. Additionally or alternatively, in step 3b, the LMF may instigate location procedure(s) with the UE, e.g., to obtain a location estimate or positioning measurement(s) or to transfer location assistance data to the UE.

In step 4, the LMF may provide a location service response to the AMF. The location service response may include any needed result(s), e.g., success or failure indication for the location service request, or a location estimate for the UE if the location estimate is requested by the AMF and obtained by the LMF.

In the case that step 1a is performed, step 5a may be performed. In step 5a, the AMF may return a location service response to the 5GC LCS entity from which the location service request is received. The location service response may include any needed result(s) received by the AMF in step 4, e.g., a location estimate for the UE.

In the case that step 1b is performed, step 5b may be performed. In step 5b, the AMF may use the location service response received in step 4 to assist the one or more location services which triggered the location service request in step 1b (e.g., the AMF may provide a location estimate associated with an emergency call to a GMLC).

In the case that step 1c is performed, step 5c may be performed. In step 5c, the AMF may return a location service response to the UE from which the location service request is received. The location service response may include any needed result(s) received by the AMF in step 4, e.g., a location estimate for the UE.

In the procedure as illustrated in FIG. 2, the LMF manages the support of different location services for target UEs, including positioning of UEs and delivery of assistance data to UEs. The LMF may interact with a target UE in order to deliver assistance data if the assistance data is requested for a particular location service, or to obtain a location estimate if the location estimate was requested. The LMF may interact with multiple NG-RAN nodes (e.g., BS) to provide assistance data information for broadcasting. However, the LMF-based solution in FIG. 2 can only be applied in the scenario where UE has ability to register in the network, i.e., the in-coverage scenario. In some cases, when a UE is out of coverage of the network or moves out of coverage of the NG-RAN, the procedure in FIG. 2 cannot be applied to the UE. Different from the Uu positioning procedure in FIG. 2, SL positioning may support all of in-coverage scenario, partial coverage scenario, and out-of-coverage scenario.

Depending on the roles of a UE and a network in a SL positioning, the SL positioning may include four kinds of SL positioning architectures, which is shown in table 1 below.

TABLE 1
Sidelink Positioning architectures

| | Entity of operation | | | |
|---|---|---|---|---|
| Sidelink | | SL-PRS | | |
| Positioning | Sidelink | Transmission | | |
| architecture | Positioning | and | Position | Positioning |
| Type | configuration | Measurement | calculation | architecture |
| (1) UE- | UE | UE | UE | UE-based |
| configured | | | | UE-based |
| and UE-based | | | | |
| (2) Network- | Network | UE | UE | |
| configured | | | | |
| and UE-based | | | | |
| (3) UE- | UE | UE | Network | UE-assisted |
| configured | | | | |
| and UE- | | | | |
| assisted | | | | |
| (4) Network- | Network | UE | Network | |
| configured | | | | |
| and UE- | | | | |
| assisted | | | | |

Referring table 1, the SL positioning may include three procedures, i.e., the sidelink positioning configuration transmission, sidelink positioning reference signal (SL-PRS) transmission and measurement, and position calculation.

Based on the entity which performs the position calculation, the SL positioning may be categorized into UE-based SL positioning and UE-assisted SL positioning. For example, in the case that the position calculation is performed by a UE, the SL positioning may be a UE-based SL positioning; in the case that the position calculation is performed by a network, the SL positioning may be a UE-assisted SL positioning.

Based on the entity which transmits the sidelink positioning configuration, the UE-based SL positioning and UE-assisted SL positioning may be further categorized into the following four SL positioning architecture:
UE-configured and UE-based SL positioning, in which the sidelink positioning configuration is transmitted by the UE and the position calculation is performed by the UE.
Network-configured and UE-based SL positioning, in which the sidelink positioning configuration is transmitted by the network and the position calculation is performed by the UE.
UE-configured and UE-assisted SL positioning, in which the sidelink positioning configuration is transmitted by the UE and the position calculation is performed by the network.
Network-configured and UE-assisted SL positioning, in which the sidelink positioning configuration is transmitted by the network and the position calculation is performed by the network.

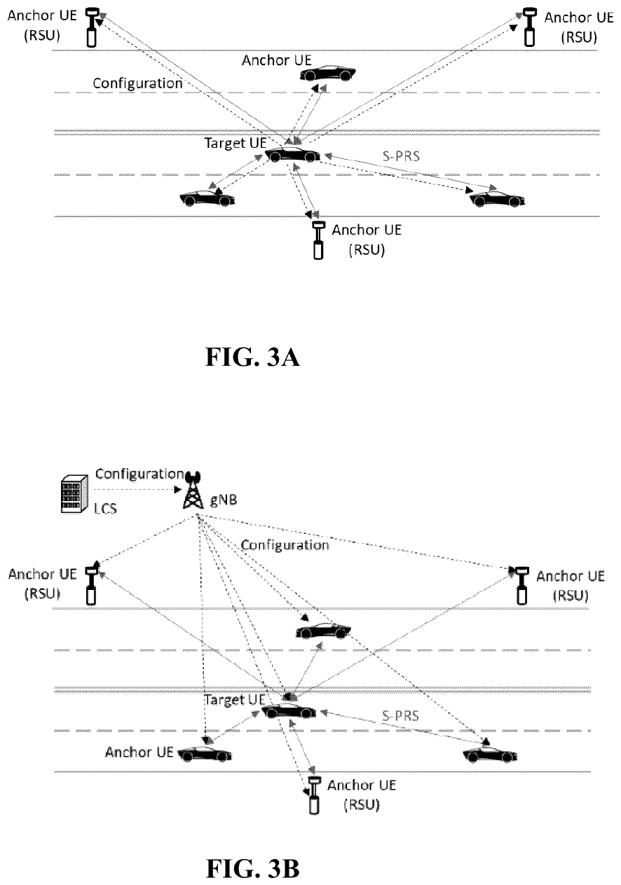

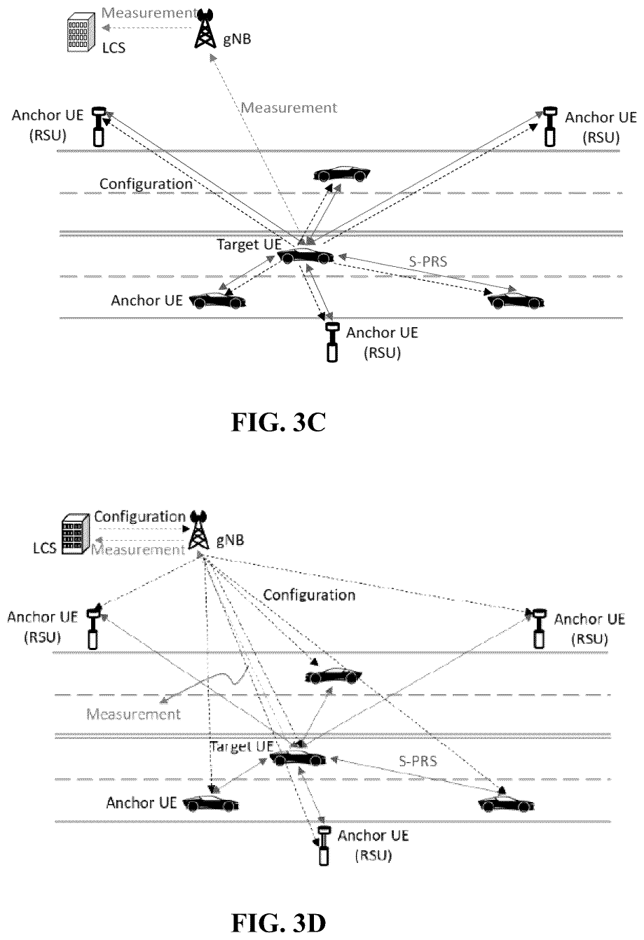

FIGS. 3A-3D illustrate four exemplary SL positioning architectures according to some embodiments of the present application.

Referring to FIG. 3A, it illustrates the UE-configured and UE-based SL positioning. In FIG. 3A, all above three sidelink positioning procedures/operations are done by the target and/or anchor UEs participating in the sidelink positioning process. UEs form a sort of sidelink positioning group and send/receive SL-PRS information to calculate the target UE position based on UE measurement. Neither Uu link nor network-based location server is involved in the sidelink positioning process. In such architecture, the target UE may determine six anchor UEs to help the target UE to acquire its position, wherein three anchor UEs are RSUs and the remaining three anchor UEs are vehicle. The target UE may transmit configuration for SL-PRS transmission to each of the anchor UEs, and then transmit the SL-PRS to each of the anchor UEs. Each of the anchor UEs may receive the SL-PRS transmitted from the target UE, and perform measurement of the SL-PRS. The anchor UEs may transmit the measurement results to the target UE. Then, the target UE may use the measurement results from the anchor UEs to calculate its position.

Referring to FIG. 3B, it illustrates the network-configured and UE-based SL positioning. In FIG. 3B, the difference between this architecture and the sidelink positioning architecture in FIG. 3A described above is that the sidelink positioning operations are controlled by the network or location server. In such architecture, both the target UE and the anchor UEs are in coverage of the network. The network entity, e.g., the location server or the base station (BS) may configure which UE will function as a target UE or an anchor UE, when to transmit/receive the SL-PRS and use which resource and sidelink positioning method (e.g., sidelink time difference of arrival (TDOA) or round-trip time (RTT), etc.), and may transmit configuration for SL-PRS transmission to the target UE and each of the anchor UEs. Then, the target UE may transmit the SL-PRS to each of the anchor UEs. Each of the anchor UEs may receive the SL-PRS transmitted from the target UE, and perform measurement of the SL-PRS. The anchor UEs may transmit the measurement results to the target UE. Then, the target UE may use the measurement results from the anchor UEs to calculate its position.

Referring to FIG. 3C, it illustrates the UE-configured and UE-assisted SL positioning. In FIG. 3C, the target UE is in coverage of the network and the anchor may be out of coverage of the network. In such architecture, the network (e.g., the BS or the LCS) or the target UE may determine six anchor UEs to help the target UE to acquire its position, wherein three anchor UEs are RSUs and the remaining three anchor UEs are vehicle. The target UE may transmit configuration for SL-PRS transmission to each of the anchor UEs, and then transmit the SL-PRS to each of the anchor UEs. Each of the anchor UEs may receive the SL-PRS transmitted from the target UE, and perform measurement of the SL-PRS. The anchor UEs may transmit the measurement results to the target UE. After receiving the measurement results, the target UE may transmit the measurement results from the anchor UEs to the network (e.g., the BS or the LCS), then the network may calculate the position of the target UE based on the measurement results.

Referring to FIG. 3D it illustrates the network-configured and UE-assisted SL positioning. In FIG. 3D, both the target UE and the anchor UEs are in coverage of the network. In such architecture, the network (e.g., the BS or the LCS) or the target UE may determine six anchor UEs to help the target UE to acquire its position, wherein three anchor UEs are RSUs and the remaining three anchor UEs are vehicle. The network may transmit configuration for SL-PRS transmission to each of the target UE and the anchor UEs. Then, the target UE may transmit the SL-PRS to each of the anchor UEs. Each of the anchor UEs may receive the SL-PRS transmitted from the target UE, and perform measurement of the SL-PRS. The anchor UEs may transmit the measurement results to the target UE. After receiving the measurement results, the target UE may transmit the measurement results from the anchor UEs to the network (e.g., the BS or the LCS), then the network may calculate the position of the target UE based on the measurement results.

According to the above SL positioning architectures, SL PRS configuration can be determined by a sidelink UE or provided by network under different SL positioning architectures, and the configurations for sidelink target UE and anchor UE should also be aligned to perform relevant SL-PRS transmission/reception. In addition, the target UE or the anchor UE may be in different states (i.e., in-coverage state or out-of-coverage state), how the target UE or the anchor UE acquires the SL PRS configuration in different states should be considered. Given this, corresponding SL positioning configuration mechanism and signalling should be defined for target UE and anchor UE by taking above architectures and states into account.

In addition, the target UE or the anchor UE may change its state, e.g., from an in-coverage state to an out-of-coverage state or from an out-of-coverage state to an in-coverage state. Given this, how to handle the SL positioning configuration by the target UE or the anchor UE when it changes its state also needs to be considered.

Moreover, the target UE or the anchor UE may perform a handover procedure. Given this, how to handle the SL positioning configuration by the target UE or the anchor UE during a handover procedure should be considered.

Given this, embodiments of the present application propose methods for SL positioning, which provide various technical solutions regarding how to acquire the SL positioning configuration by a target UE and an anchor UE in different states, how to handle the SL positioning configuration by the target UE or the anchor UE when it changes its state, and how to handle the SL positioning configuration by the target UE or the anchor UE during a handover procedure. More details on embodiments of the present application will be described in the following text in combination with the appended drawings.

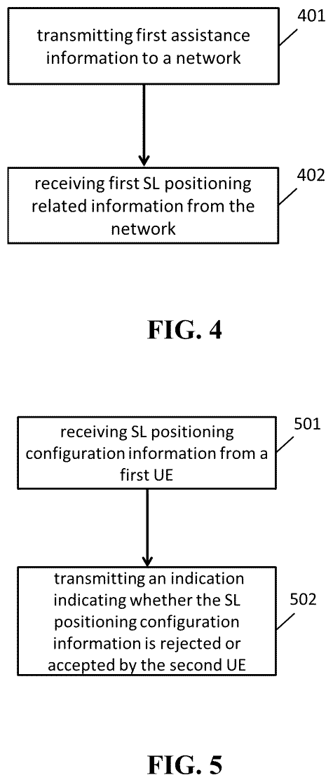

FIG. 4 is a flow chart illustrating an exemplary method for SL positioning according to some embodiments of the present application. The method illustrated in FIG. 4 may be performed by a first UE (e.g., a target UE). The target UE may be a UE at which a location service request is initiated or occurs. In other words, the target UE may be a UE that wants to know its own position. Persons skilled in the art can understand that the method described with respect to the UE can be implemented by other apparatus with the like functions.

In the embodiments of FIG. 4, the first UE is in an RRC-connected state.

In the exemplary method shown in FIG. 4, in step 401, the first UE may transmit first assistance information to the network.

In some embodiments of the present application, the first UE may transmit the first assistance information in or with an on-demand request for SL positioning configuration information to the network to help the network to provide the SL positioning configuration. In an embodiment of the present application, the on-demand request may be an LPP message to a LMF, e.g., requestAssistanceData message or a ProvideCapabilities message as specified in 3GPP standards documents. In another embodiment of the present application, the on-demand request may be transmitted in a dedicated RRC signaling to a serving BS.

In some embodiments of the present application, the first UE may transmit the first assistance information to a LMF via an LPP signaling or to a serving BS of the first UE via an RRC signaling.

The first assistance information may include UE information associated with at least one second UE. Each of the at least one second UE may be an anchor UE. The anchor UE may be a UE that participates in SL positioning and helps the first UE to acquire its position, e.g., by sending/receiving SL PRS and doing relevant measurements.

For example, the first UE may be UE 102a as shown in FIG. 1 and the at least one second UE may be UE 102b and UE 102c as shown in FIG. 1. In another example, the first UE may be UE 102d as shown in FIG. 1 and the at least one second UE may be UE 102b and UE 102c as shown in FIG. 1.

In some embodiments of the present application, in addition to the UE information associated with at least one second UE, the first assistance information may further include at least one of:
Location service requirement(s) associated with the first UE. The location service requirement(s) may include at least one of: relative positioning, absolute positioning, accuracy requirements, response time, etc.
Configuration parameter(s) requested by the first UE from the network. In some embodiments of the present application, the configuration parameter(s) may also be replaced with a configuration index, the configuration index may correspond to a set of configuration parameter(s). After receiving the configuration index, the network may know which configuration parameter(s) are requested by the first UE.
Schedule location time of the first UE, which indicate a future global time (e.g., universal time coordinated (UTC)) at which first UE is to be located.

In an embodiment of the present application, the at least one second UE may be determined by the first UE. In such embodiment, the UE information associated with the at least one second UE may include at least one of:
an identification of each of the at least one second UE; for example, the identification may be a layer-2 identity (ID), a cell radio network temporary identifier (C-RNTI) if the second UE is within the same cell coverage with the first UE, etc.
the number of second UE(s);
a status of each of the at least one second UE; the status may be an in-coverage status or out-of-coverage status;
serving cell information of each of the at least one second UE in the second cell is not within a coverage of a BS;
UE capability associated with SL positioning of each of the at least one second UE; the UE capability associated with SL positioning may include at least one of: supported carrier, supported bandwidth, supported density, and other contents for transmitting/receiving SL-PRS or supported positioning methods; or
a candidate UE list including an index of each of the at least one second UE; for example, assuming that the at least one second UE includes three UEs, the indexes of the three UEs are UE 1, UE 2, and UE 3, then the candidate UE list may include the UE 1, UE 2, and UE 3.

In another embodiment of the present application, the at least one second UE may be determined by the network based on the UE information. In such embodiment, the UE information includes at least one of:
a minimum number of second UEs helping the first UE to acquire its position; for example, assuming that minimum number of second UEs is three, then the network may determine three second UEs, i.e., the number of the second UEs is three; or
a preferred UE type of each of the second UEs helping the first UE to acquire its position. The preferred UE type may include at least one of: stationary UE, moving UE, RSU, P-UE, V-UE, etc.

According to some embodiments of the present application, the first UE may transmit the first assistance information to the network in response to at least one of the following conditions:
measurement quality for SL positioning meets a threshold, which includes at least one of: the measurement quality between the first UE and at least one anchor UE which is currently used for helping the first UE to acquire its position meets a specified threshold (e.g., decreasing to a threshold); or change in radio conditions between the first UE and at least one anchor UE which is currently used for helping the first UE to acquire its position meets a specified threshold; or
current SL positioning configuration used by the first UE cannot satisfy QoS requirement(s) (e.g., accuracy requirement).

After transmitting the first assistance information to the network. In step 402, the first UE may receive first SL positioning related information from the network. In some embodiments of the present application, the first UE may receive the first SL positioning related information from the LMF via an LPP signaling or from the serving BS via an RRC signaling.

In some embodiments of the present application, the first SL positioning related information may include at least one mapping, each mapping is a mapping between a SL positioning configuration and a corresponding sidelink destination ID.

Alternatively or additionally, the first SL positioning related information may include at least one mapping, each mapping a mapping between a SL positioning configuration and a corresponding second UE (e.g., a UE ID or a UE index) of the at least one second UE.

Alternatively or additionally, the first SL positioning related information may include at least one mapping, each mapping is a mapping between a SL positioning configuration and a corresponding SL positioning capability index. For example, the SL positioning capability index may indicate a SL positioning capability included in the first assistance information.

In an embodiment of the present application, the SL positioning configuration included in the first SL positioning related information may include at least one of:
information for transmitting or receiving SL-PRS; for example, information for transmitting or receiving SL-PRS may include parameters related to: when to transmit or receive the SL-PRS and using which resources to transmit or receive the SL-PRS, e.g., the parameters may include periodicity for transmitting or receiving SL-PRS, bandwidth transmitting or receiving SL-PRS, reception time of SL-PRS, etc.;
information for measuring the SL-PRS; for example, the information for measuring the SL-PRS may include: SL-PRS measurement window, measurement index, etc.; or
information for reporting a measurement result of the SL-PRS; for example, the information for reporting a measurement result of the SL-PRS may include at least one of: the content to be reported, the periodicity for reporting the measurement result, the event for reporting the measurement result, etc.

In the embodiments of FIG. 4, the network may transmit first SL positioning related information in response to the first assistance information. However, in some other embodiments of the present application, the network may also provide first SL positioning related information to the first UE by implementation when no assistance information is received from the first UE.

In some other embodiments of the present application, the first UE may not transmit the first assistance information to the network. Instead, in response to a mobile originated (MO) location service request received from the first UE or a mobile terminated (MT) location request received from the AMF, the LMF may transmit the first SL positioning related information in the assistance data to the first UE, or the LMF may transmit the first SL positioning related information to the serving BS of the first UE such that the serving BS may transmit the first SL positioning related information in a PosSIB to the first UE.

The embodiments in FIG. 4 illustrate how to obtain a SL positioning configuration when the first UE (e.g., target UE) is in an RRC-connected state.

According to some other embodiments of the present application, the first UE (e.g., target UE) may be an RRC-idle UE, an RRC-inactive UE, or a UE which is in an out-of-coverage state (e.g., out of coverage of a network). Then, the first UE (e.g., target UE) may obtain SL positioning related information by its implementation or by pre-configuration information.

According to some embodiments of the present application, the first UE (e.g., target UE) may receive the pre-configuration information (e.g., SL positioning related information) is SIB (e.g., SL PosSIB) (e.g., for the case that the first UE is in an RRC-idle state or in an RRC-inactive state). According to some other embodiments of the present application, the pre-configuration information (e.g., SL positioning related information) may be in the first UE or fixed or pre-defined in the 3GPP standard documents (e.g., for the case that the first UE is in an out-of-coverage state).

In some embodiments of the present application, the pre-configuration information includes at least one mapping, each mapping of the at least one mapping is a mapping between a SL positioning configuration and a corresponding accuracy requirement. For example, the pre-configuration information may include three mappings (e.g., mapping #1, mapping #2, and mapping #3), wherein mapping #1 is a mapping between a SL positioning configuration and a accuracy requirement #1 (which is represent by a set of information (e.g., set #1)), mapping #2 is a mapping between a SL positioning configuration and a accuracy requirement #2 (which is represent by a set of information (e.g., set #2)), and mapping #3 is a mapping between a SL positioning configuration and a accuracy requirement #3 (which is represent by a set of information (e.g., set #3)).

Alternatively or additionally, the pre-configuration information includes at least one mapping, each mapping of the at least one mapping is a mapping between a SL positioning configuration and a corresponding number of second UEs, wherein each of the second UE helps the first UE to acquire its position. That is, the second UE may be an anchor UE. For example, the pre-configuration information may include three mappings (e.g., mapping #1, mapping #2, and mapping #3), wherein mapping #1 is a mapping between a SL positioning configuration and three second UEs, mapping #2 is a mapping between a SL positioning configuration and four second UEs, and mapping #3 is a mapping between a SL positioning configuration and five second UEs.

Alternatively or additionally, the pre-configuration information includes at least one mapping, each mapping of the at least one mapping is a mapping between a SL positioning configuration and a corresponding SL positioning method. The SL positioning methods may include time difference of arrival (TDOA) positioning method, round-trip time (RTT) positioning method, angel of arrival (AOA)/angel of departure (AOD) positioning method, etc. For example, the pre-configuration information may include three mappings (e.g., mapping #1, mapping #2, and mapping #3), wherein mapping #1 is a mapping between a SL positioning configuration and a TDOA positioning method, mapping #2 is a mapping between a SL positioning configuration and an RTT positioning method, and mapping #3 is a mapping between a SL positioning configuration and an AOA/AOD positioning method.

Alternatively or additionally, the pre-configuration information includes at least one mapping, each mapping of the at least one mapping is a mapping between a SL positioning configuration and a corresponding QoS or a radio condition. For example, the pre-configuration information may include three mappings (e.g., mapping #1, mapping #2, and mapping #3), wherein mapping #1 is a mapping between a SL positioning configuration and a QoS #1, mapping #2 is a mapping between a SL positioning configuration and a QoS #2, and mapping #3 is a mapping between a SL positioning configuration and a QoS #3.

In some embodiments of the present application, the pre-configuration information may include a valid condition or is pre-configured with a valid condition. The valid condition may including at least one of:
a valid area for the pre-configuration information; that is, the pre-configuration information is valid in the valid area. For example, the valid area may be an area centered on an anchor UE; or
a valid timer period for the pre-configuration information; that is, the pre-configuration information is valid during the time period.

In some embodiments of the present application, the first UE (e.g., target UE) may trigger a RRC establishment request to its serving BS if the pre-configuration information cannot satisfy the accuracy requirement.

According to some embodiments of the present application, after receiving the first SL positioning related information from the BS (e.g., for the case that the first UE is in RRC-connected state) or after obtaining SL positioning related information in pre-configuration information (e.g., for the case that the first UE is in an RRC-idle state or in an RRC-inactive state, the first UE (e.g., target UE) may receive the pre-configuration information is SIB; for the case that the first UE is in an out-of-coverage state, the pre-configuration information may be in the first UE or fixed or pre-defined in the 3GPP standard documents), the first UE (e.g., the target UE) may transmit SL positioning configuration information to a second UE of the at least second UE. The second UE may be an anchor UE which helps the first UE to acquire its position.

The SL positioning configuration information may be generated based on the first SL positioning related information (e.g., for the case that the first UE is in RRC-connected state) or generated based on SL positioning related information in pre-configuration information (e.g., for the case that the first UE is in RRC-idle/inactive state, or the first UE is in out-of-coverage state).

The SL positioning configuration information may include a SL positioning configuration or an index associated with (e.g., indicating) the SL positioning configuration. In the case that the SL positioning configuration information includes an index associated with the SL positioning configuration, the mapping between the index and the SL positioning configuration may be pre-defined to the second UE. As stated above, the SL positioning configuration may include at least one of: information for transmitting or receiving SL-PRS; information for measuring the SL-PRS; or information for reporting a measurement result of the SL-PRS.

In some embodiments of the present application, the SL positioning configuration information may be transmitted in an RRC message (e.g., an RRCReconfigurationSidelink message or a new RRC message different from the RRC messages as specified in 3GPP standard documents). In some other embodiments of the present application, the SL positioning configuration information may be transmitted in an upper layer (e.g., a layer higher than the RRC layer) signaling for positioning.

In some embodiments of the present application, the first UE may transmit the SL positioning configuration information to the second UE in response to at least one of the following conditions:
the first UE determines the SL positioning configuration; for example, the first UE may determine the SL positioning configuration from network (e.g., for the case that the first UE is in RRC-connected state), or the first UE may determine the SL positioning configuration in pre-configuration information (e.g., for the case that the first UE is in RRC-idle/inactive state, or the first UE is in out-of-coverage state);
the second UE is determined by the first UE;
UE information of the second UE is acquired by the first UE (e.g., from network);
the SL RRC connection between first UE and second UE are established, for example, the SL positioning configuration can be transmitted with RRCReconfigurationSidelink message; or
the first UE receives a configuration request from the second UE.

In some embodiments of the present application, before transmitting the SL positioning configuration information from the first UE to the second UE, a sidelink unicast connection between the first UE and the second UE should be established.

After transmitting the SL positioning configuration information, the first UE may receive an indication from the second UE. The indication may indicate whether the SL positioning configuration information is rejected or accepted by the second UE. After receiving the indication, in the case that the SL positioning configuration information is provided by the network (e.g., for the case that the first UE is in RRC-connected state), the first UE may transmit the received indication to the network.

In some embodiments of the present application, before transmitting the SL positioning configuration information from the first UE to the second UE, the first UE may receive second assistance information from the second UE. The second assistance information may include at least one of:
at least one SL positioning configuration related to at least one target UE different from the first UE, wherein each SL positioning configuration may be associated with a corresponding target UE; that is, the second UE helps the at least one target UE to acquire the position of the at least one target UE;
PRS configuration in Uu interface; or
SRS configuration in Uu interface.

After receiving the second assistance information, the first UE may provide the SL positioning configuration information to the second UE based on the second assistance information.

According to some embodiments of the present application, the state of the first UE (e.g., target UE) may change. That is, the state of the first UE may be changed from an in-coverage state to an out-of-coverage state or may be changed from an out-of-coverage state to an in-coverage state.

In some embodiments of the present application, when a state of the first UE is changed from an in-coverage state to an out-of-coverage state, the first UE may perform at least one of:
keeping using the first SL positioning related information which is used in the in-coverage state until the first SL positioning related information becomes invalid (e.g., the defined valid conditions for the first SL positioning related information expire);
acquiring second SL positioning related information in the out-of-coverage state and keep using the first SL positioning related information in the in-coverage state until the second SL positioning related information is available; or
using default SL positioning related information during a time period from the first SL positioning related information becomes invalid to the second SL positioning related information is available; the default SL positioning related information is pre-defined.

The second SL positioning related information may be acquired by pre-configuration information. As stated above, the first UE may receive the pre-configuration information (e.g. second SL positioning related information) is SIB or the pre-configuration information (e.g. second SL positioning related information) may be fixed or pre-defined in the 3GPP standard documents.

In an embodiment of the present application, the pre-configuration information includes at least one mapping, each mapping of the at least one mapping is a mapping between a SL positioning configuration and a corresponding accuracy requirement.

Alternatively or additionally, the pre-configuration information includes at least one mapping, each mapping of the at least one mapping is a mapping between a SL positioning configuration and a corresponding number of third UEs, wherein each of the third UE helps the first UE to acquire its position. That is, the third UE may be an anchor UE.

Alternatively or additionally, the pre-configuration information includes at least one mapping, each mapping of the at least one mapping is a mapping between a SL positioning configuration and a corresponding SL positioning method. The SL positioning methods may include TDOA positioning method, RTT positioning method, AOA/AOD positioning method, etc.

Alternatively or additionally, the pre-configuration information includes at least one mapping, each mapping of the at least one mapping is a mapping between a SL positioning configuration and a corresponding QoS or a radio condition.

In an embodiment of the present application, the pre-configuration information may include a valid condition or is pre-configured with a valid condition. The valid condition may include at least one of: a valid area for the pre-configuration information; or a valid timer period for the pre-configuration information.

In some other embodiments of the present application, when a state of the first UE is changed from an out-of-coverage state to an in-coverage state, the first UE may report third SL positioning related information to the network, wherein the third SL positioning related information may include at least one of:
UE information associated with at least one fourth UE, wherein the at least one fourth UE helps the first UE to acquire its position in the out-of-coverage state. For example, the UE information may include at least one of: the number of fourth UE(s), the RRC state (e.g., RRC-connected, RRC-idle, or RRC-inactive, or out-of-coverage state) of each of the at least one fourth UE, and the serving cell information of each of the at least one fourth UE.
SL positioning configuration associated with each of the at least one fourth UE. As stated above, the SL positioning configuration may include at least one of: information for transmitting or receiving SL-PRS between the first UE and the fourth UE; information for measuring the SL-PRS; or information for reporting a measurement result of the SL-PRS.
Third assistance information (or a request) for acquiring new SL positioning configuration(s). The third assistance information may include at least one of: UE information associated with at least one anchor UE, location service requirement(s) associated with the first UE; configuration parameter(s) requested by the first UE from the network; or schedule location time of the first UE.

In some embodiments of the present application, when a state of the first UE is changed from an out-of-coverage state to an in-coverage state, the first UE keeps using the SL positioning configuration(s) in previous state (e.g., in the out-of-coverage state) until the new SL positioning configuration(s) is available.

In NR, the handover happens more frequently than in LTE network because the cell of NR is smaller than that in LTE. In some cases, a handover of the first UE (e.g., a target UE) has been triggered prior to the expected completion time of the previously communicated SL-PRS configuration(s) of the first UE.

In such cases, according to some embodiments of the present application, the first UE may report fourth SL positioning related information used in a source cell to the network after a handover procedure to a target cell is completed. The handover procedure to a target cell being completed may refer to a random access to the target UE is successful and the first UE enters into an RRC-connected state.

The fourth SL positioning related information is generated based on the first SL positioning related information and includes at least one of:
UE information associated with at least one second UE. For example, the UE information may include at least one of: the number of second UE(s), the RRC state (e.g., RRC-connected, RRC-idle, RRC-inactive, or out-of-coverage state) of each of the at least one second UE, and the serving cell information of each of the at least one second UE.
SL positioning configuration associated with each of the at least second UE. As stated above, the SL positioning configuration may include at least one of: information for transmitting or receiving SL-PRS between the first UE and the second UE; information for measuring the SL-PRS; or information for reporting a measurement result of the SL-PRS.

In such cases, the first UE may keep using the fourth SL positioning related information before receiving new positioning related information for the target cell from the network. In an embodiment of the present application, the first UE may use the fourth SL positioning related information when at least one of the following timers is running: a first timer (e.g., timer T304 as specified in 3GPP standard documents) which is started when receiving an RRC reconfiguration message during the handover procedure; or a second timer (e.g., timer T310 as specified in 3GPP standard documents) which is started when initiating an RRC connection re-establishment procedure.

According to some other embodiments of the present application, the first UE may receive new positioning related information for a target cell in a handover command from a source cell. The new positioning related information may include the similar items as those included in the first positioning related information.

After receiving the new positioning related information, the first UE may use using the new positioning related information during a handover procedure. Alternatively or additionally, the first UE may use using the new positioning related information after a handover procedure to a target cell is completed.

In an embodiment of the present application, the first UE may use the new SL positioning related information when at least one of the following timers is running: a first timer (e.g., timer T304 as specified in 3GPP standard documents) which is started when receiving an RRC reconfiguration message during the handover procedure; or a second timer (e.g., timer T310 as specified in 3GPP standard documents) which is started when initiating an RRC connection re-establishment procedure.

In some embodiments of the present application, after the handover is completed, whether to request or provide other SL positioning related information different from the new positioning related information is up to UE's implementation or network's implementation.

FIG. 5 is a flow chart illustrating an exemplary method for SL positioning according to some other embodiments of the present application. The method illustrated in FIG. 5 may be performed by a second UE (e.g., an anchor UE). The anchor UE may be a UE that participates in SL positioning and helps a first UE (e.g., a target UE) to acquire its position, e.g., by sending/receiving SL PRS and doing relevant measurements. The target UE may be a UE at which a location service request is initiated or occurs. In other words, the target UE may be a UE that wants to know its own position. Persons skilled in the art can understand that the method described with respect to the UE can be implemented by other apparatus with the like functions.

For example, the first UE may be UE 102a as shown in FIG. 1 and the second UE may be UE 102b or UE 102c as shown in FIG. 1. In another example, the first UE may be UE 102d as shown in FIG. 1 and the second UE may be UE 102b or UE 102c as shown in FIG. 1.

In the embodiments of FIG. 5, regardless of the state of the second UE (e.g., the second UE may be in an in-coverage state, may be in an RRC-connected state, may be in an out-of-coverage state, may be in an RRC-idle state, or may be in an RRC-inactive state), the second UE may receive the SL positioning configuration information from the first UE (e.g., the target UE).

Specifically, in step 501, the second UE (e.g., the anchor UE) may receive SL positioning configuration information from the first UE (e.g., the target UE). For example, the SL positioning configuration information may be generated based on the first SL positioning related information (e.g., for the case that the first UE is in RRC-connected state) or generated based on SL positioning related information in pre-configuration information (e.g., for the case that the first UE is in RRC-idle/inactive state, or the first UE is in out-of-coverage state).

The SL positioning configuration information may include a SL positioning configuration or an index associated with (e.g., indicating) the SL positioning configuration. In the case that the SL positioning configuration information includes an index associated with the SL positioning configuration, the mapping between the index and the SL positioning configuration may be pre-defined to the second UE. As stated above, the SL positioning configuration may include at least one of: information for transmitting or receiving SL-PRS; information for measuring the SL-PRS; or information for reporting a measurement result of the SL-PRS.

In some embodiments of the present application, the SL positioning configuration information may be received in an RRC message (e.g., an RRCReconfigurationSidelink message or a new RRC message different from the RRC messages as specified in 3GPP standard documents). In some other embodiments of the present application, the SL positioning configuration information may be received in an upper layer (e.g., a layer higher than the RRC layer) signaling for positioning.

In some embodiments of the present application, before receiving the SL positioning configuration information from the first UE, a sidelink unicast connection between the first UE and the second UE should be established.

After receiving the SL positioning configuration information, the second UE may transmit an indication to the first UE. The indication may indicate whether the SL positioning configuration information is rejected or accepted by the second UE.

In some embodiments of the present application, before receiving the SL positioning configuration information from the first UE, the second UE may transmit assistance information to the first UE. The assistance information may include at least one of:
at least one SL positioning configuration related to at least one target UE different from the first UE, wherein each SL positioning configuration may be associated with a corresponding target UE; that is, the second UE helps the at least one target UE to acquire the position of the at least one target UE;
PRS configuration in Uu interface; or
SRS configuration in Uu interface.

According to some embodiments of the present application, the second UE may transmit the SL positioning configuration information to the network in the case that the second UE is in-coverage of the network and determines to use the received SL positioning configuration information.

According to some embodiments of the present application, the state of the second UE (e.g., anchor UE) may change. That is, the state of the second UE may be changed from an in-coverage state to an out-of-coverage state or may be changed from an out-of-coverage state to an in-coverage state.

In some embodiments of the present application, when a state of the second UE is changed from an in-coverage state to an out-of-coverage state, in the case that the SL positioning configuration information is received from the target UE, there is no impact for the second UE. However, in some cases, the SL positioning configuration information is obtained from the network, then the second UE may perform the same operations as those performed by the first UE when the state of the first UE is changed from an in-coverage state to an out-of-coverage state. For example, the second UE may perform at least one of the followings:
keeping using the SL positioning configuration information which is used in the in-coverage state (e.g., obtained based on assistance data or in PosSIB) until the SL positioning configuration information becomes invalid (e.g., the defined valid conditions for the SL positioning configuration information expire);
acquiring other SL positioning configuration information in the out-of-coverage state and keep using the SL positioning configuration information in the in-coverage state until the other SL positioning configuration information is available; or
using default SL positioning configuration information during a time period from the first SL positioning configuration information becomes invalid to the other SL positioning configuration information is available; the default SL positioning configuration information is pre-defined.

In some other embodiments of the present application, when a state of the second UE is changed from an out-of-coverage state to an in-coverage state, the second UE may transmit the SL positioning configuration information to the network in the case that the second UE connects to the network.

In NR, the handover happens more frequently than in LTE network because the cell of NR is smaller than that in LTE. In some cases, a handover of the second UE (e.g., an anchor UE) has been triggered prior to the expected completion time of the previously communicated SL-PRS configuration(s) of the second UE.

In such cases, according to some embodiments of the present application, the second UE may report the SL positioning configuration information received from the first UE to the network after a handover procedure to a target cell is completed. The handover procedure to a target cell being completed may refer to a random access to the target UE is successful and the first UE enters into an RRC-connected state.

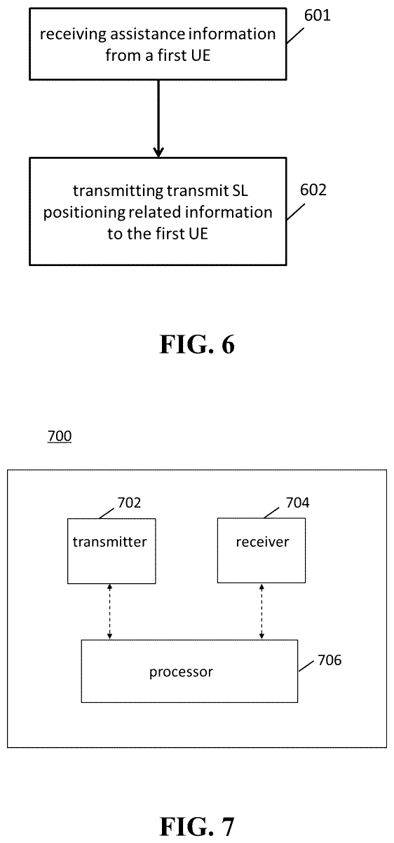

FIG. 6 is a flow chart illustrating an exemplary method for SL positioning according to some other embodiments of the present application. The method illustrated in FIG. 6 may be performed by a network entity (e.g., a LMF or a BS). Persons skilled in the art can understand that the method described with respect to the UE can be implemented by other apparatus with the like functions.

In the exemplary method shown in FIG. 6, in step 601, the network entity may receive assistance information from a first UE (e.g., the target UE). The target UE may be a UE at which a location service request is initiated or occurs. In other words, the target UE may be a UE that wants to know its own position.

In some embodiments of the present application, the network entity may receive the assistance information in or with an on-demand request for SL positioning configuration information. In an embodiment of the present application, the network entity may be an LMF and the on-demand request may be an LPP message from the first UE, e.g., requestAssistanceData message or a ProvideCapabilities message as specified in 3GPP standards documents. In another embodiment of the present application, the network entity may be a serving BS of the first UE and the on-demand request may be received in a dedicated RRC signaling from the first UE.

In some embodiments of the present application, the network entity may be an LMF and the LMF receives the assistance information via an LPP signaling. In some other embodiments of the present application, the network entity may be a serving BS of the serving BS receives the assistance information via an RRC signaling.

The assistance information may include UE information associated with at least one second UE. Each of the at least one second UE may be an anchor UE. The anchor UE may be a UE that participates in SL positioning and helps the first UE to acquire its position, e.g., by sending/receiving SL PRS and doing relevant measurements.

For example, the first UE may be UE 102a as shown in FIG. 1 and the at least one second UE may be UE 102b and UE 102c as shown in FIG. 1. In another example, the first UE may be UE 102d as shown in FIG. 1 and the at least one second UE may be UE 102b and UE 102c as shown in FIG. 1.

In some embodiments of the present application, in addition to the UE information associated with at least one second UE, the assistance information may further include at least one of:
location service requirement(s) associated with the first UE;
configuration parameter(s) requested by the first UE from the network; or
schedule location time of the first UE.

In an embodiment of the present application, the at least one second UE may be determined by the first UE. In such embodiment, the UE information associated with the at least one second UE may include at least one of:
an identification of each of the at least one second UE;
the number of UE(s);
a status of each of the at least one second UE;
serving cell information of each of the at least one second UE in the second cell is not within a coverage of a BS;
UE capability associated with SL positioning of each of the at least one second UE; or
a candidate UE list including an index of each of the at least one second UE.

In another embodiment of the present application, the at least one second UE may be determined by the network based on the UE information. In such embodiment, the UE information includes at least one of:
a minimum number of second UEs helping the first UE to acquire its position; or
a preferred UE type of each of the second UEs helping the first UE to acquire its position.

After receiving the assistance information to the network. In step 602, the network entity may transmit SL positioning related information to the first UE. In some embodiments of the present application, the network entity may be a LMF and the LMF may transmit the SL positioning related information to the first UE via an LPP signaling. In some embodiments of the present application, the network entity may be a serving BS of the first UE and the serving BS may transmit the SL positioning related information to the first UE via an RRC signaling.

In some embodiments of the present application, the SL positioning related information may include at least one mapping, each mapping is a mapping between a SL positioning configuration and a corresponding sidelink destination ID.

Alternatively or additionally, the SL positioning related information may include at least one mapping, each mapping a mapping between a SL positioning configuration and a corresponding second UE (e.g., a UE ID or a UE index) of the at least one second UE.

Alternatively or additionally, the SL positioning related information may include at least one mapping, each mapping is a mapping between a SL positioning configuration and a corresponding SL positioning capability index. For example, the SL positioning capability index may indicate a SL positioning capability included in the assistance information.

In an embodiment of the present application, the SL positioning configuration included in the SL positioning related information may include at least one of:
information for transmitting or receiving SL-PRS;
information for measuring the SL-PRS; or
information for reporting a measurement result of the SL-PRS.

In the embodiments of FIG. 6, the network may transmit the SL positioning related information in response to the assistance information. However, in some other embodiments of the present application, the network may also provide SL positioning related information to the first UE by implementation when no assistance information is received from the first UE.

In some other embodiments of the present application, the first UE may not transmit the assistance information to the network. Instead, in response to a MO location service request received from the first UE or a MT location request received from the AMF, the LMF may transmit the first SL positioning related information in the assistance data to the first UE, or the LMF may transmit the first SL positioning related information to the serving BS of the first UE such that the serving BS may transmit the first SL positioning related information in a PosSIB to the first UE.

According to some embodiments of the present application, a handover of the first UE has been triggered prior to the expected completion time of the previously communicated SL-PRS configuration, in such embodiments, the serving BS may transmit the SL positioning related information in a handover request of a handover procedure to target cell of the first UE. Alternatively or additionally, the serving BS may also transmit an indication in the handover request to the target cell. The indication indicates the target cell that the SL positioning related information is kept being used by the first UE during the handover procedure until the first UE connects to the target cell and acquires new SL positioning related information from target cell.

In such embodiments, the first UE may keep using the SL positioning related information when at least one of the following timers is running: a first timer (e.g., timer T304 as specified in 3GPP standard documents) which is started when receiving an RRC reconfiguration message during the handover procedure; or a second timer (e.g., timer T310 as specified in 3GPP standard documents) which is started when initiating an RRC connection re-establishment procedure.

According to some embodiments of the present application, a handover of the second UE has been triggered prior to the expected completion time of the previously communicated SL-PRS configuration, in such embodiments, the serving BS may transmit the received SL positioning related information from the second UE in a handover request of a handover procedure to target cell of the second UE. As stated above, the second UE may transmit SL positioning related information obtained from the first UE when the second UE is in coverage the serving BS or the state of the second UE is changed from an out-of-coverage state to an in-coverage state.

Alternatively or additionally, the serving BS may also transmit an indication in the handover request to the target cell. The indication indicates the target cell that the SL positioning related information is kept being used by the second UE during the handover procedure until the second UE connects to the target cell and acquires new SL positioning related information from target cell.

According to some embodiments of the present application, the serving BS may receive new SL positioning related information associated with the first UE or the second UE from the target cell. Then, the UE may transmit the new SL positioning related information associated with the first UE or the second UE to the first UE or the second UE in a handover command. In some embodiments, the serving BS may also transmit the new SL positioning related information associated with the first UE or the second obtained from the target cell to the LMF after deciding to perform a handover execution, so as to inform the new SL positioning related information to the LMF.

FIG. 7 illustrates a simplified block diagram of an exemplary apparatus 700 for SL positioning according to some embodiments of the present application. The apparatus 700 may be a first UE (e.g., a target UE), a second UE (e.g., an anchor UE), or a network entity (e.g., a LMF or a BS).

Referring to FIG. 7, the apparatus 700 may include at least one transmitter 702, at least one receiver 704, and at least one processor 706. The at least one transmitter 702 is coupled to the at least one processor 706, and the at least one receiver 704 is coupled to the at least one processor 706.

Although in this figure, elements such as the transmitter 702, the receiver 704, and the processor 706 are illustrated in the singular, the plural is contemplated unless a limitation to the singular is explicitly stated. In some embodiments of the present application, the transmitter 702 and the receiver 704 may be combined to one device, such as a transceiver. In some embodiments of the present application, the apparatus 700 may further include an input device, a memory, and/or other components. The transmitter 702, the receiver 704, and the processor 706 may be configured to perform any of the methods described herein (e.g., the method described with respect to any of FIGS. 4-6).

According to some embodiments of the present application, the apparatus 700 may be a first UE. In some embodiments of the present application, the transmitter 702 is configured to transmit first assistance information to a network, wherein the first assistance information includes UE information associated with at least one second UE, and wherein the at least one second UE helps the first UE to acquire its position. The receiver 704 is configured to receive first SL positioning related information from the network.

In some embodiments of the present application, the first assistance information further includes at least one of: location service requirement(s) associated with the first UE; configuration parameter(s) requested by the first UE from the network; or schedule location time of the first UE.

In some embodiments of the present application, the at least one second UE is determined by the first UE, and the UE information includes at least one of: an identification of each of the at least one second UE; the number of second UE(s); a status of each of the at least one second UE; serving cell information of each of the at least one second UE; UE capability associated with SL positioning of each of the at least one second UE; or a candidate UE list including an index of each of the at least one second UE.

In some embodiments of the present application, the at least one second UE is determined by the network based on the UE information, and the UE information includes at least one of: a minimum number of second UEs helping the first UE to acquire its position; or a preferred UE type of each of the second UEs helping the first UE to acquire its position.

In some embodiments of the present application, the transmitter 702 is configured to transmit the first assistance information to the network in response to at least one of the following conditions: measurement quality for SL positioning meets a threshold; or current SL positioning configuration cannot satisfy QOS requirement(s).

In some embodiments of the present application, the method may further include: transmitting the first assistance information to an LMF via an LPP signaling or to a serving BS via an RRC signaling.

In some embodiments of the present application, the first SL positioning related information includes at least one mapping, and wherein each mapping is: a mapping between a SL positioning configuration and a corresponding sidelink destination ID; a mapping between a SL positioning configuration and a corresponding second UE of the at least one second UE; or a mapping between a SL positioning configuration and a corresponding SL positioning capability index.

In some embodiments of the present application, the SL positioning configuration includes at least one of: information for transmitting or receiving SL-PRS; information for measuring the SL-PRS; or information for reporting a measurement result of the SL-PRS.

In some embodiments of the present application, the receiver 704 is configured to receive the first SL positioning related information from a LMF via an LPP signaling or from a serving BS via an RRC signaling.

In some embodiments of the present application, the transmitter 702 is further configured to transmit SL positioning configuration information to a second UE of the at least second UE, and wherein the receiver is further configured to receive an indication indicating whether the SL positioning configuration information is rejected or accepted by the second UE, wherein the SL positioning configuration information is generated based on the first SL positioning related information and includes a SL positioning configuration or an index associated with the SL positioning configuration.

In some embodiments of the present application, the transmitter 702 is further configured to transmit the received indication to the network.

In some embodiments of the present application, the transmitter 702 is further configured to transmit the SL positioning configuration information to the second UE in response to at least one of the following conditions: the first UE determines the SL positioning configuration; the second UE is determined by the first UE; UE information of the second UE is acquired by the first UE; the SL RRC connection between first UE and second UE are established; or the first UE receives a configuration request from the second UE.

In some embodiments of the present application, the receiver 704 is further configured to receive second assistance information from the second UE before transmitting the SL positioning configuration information to a second UE.

In some embodiments of the present application, the transmitter 702 is further configured to transmit transmitting SL positioning configuration information to the second UE in a RRC message or in an upper layer signaling for SL positioning.

In some embodiments of the present application, wherein a state of the first UE is changed from an in-coverage state to an out-of-coverage state, the processor 706 is configured to perform at least one of the following: keeping using the first SL positioning related information until the first SL positioning related information becomes invalid; acquiring second SL positioning related information in the out-of-coverage state and keeping using the first SL positioning related information in the in-coverage state until the second SL positioning related information is available, wherein the second SL positioning related information is acquired by pre-configuration information; or using default SL positioning related information during a time period from the first SL positioning related information becomes invalid to the second SL positioning related information is available, wherein the default SL positioning related information is pre-defined.

In some embodiments of the present application, the pre-configuration information includes at least one mapping, each mapping of the at least one mapping is one of: a mapping between a SL positioning configuration and a corresponding accuracy requirement; a mapping between a SL positioning configuration and a corresponding number of third UEs, wherein each of the third UE helps the first UE to acquire its position; a mapping between a SL positioning configuration and a corresponding SL positioning method; and a mapping between a SL positioning configuration and a corresponding QoS or a radio condition.

In some embodiments of the present application, the pre-configuration information is pre-configured with a valid condition including at least one of: a valid area for the pre-configuration information; and a valid timer period for the pre-configuration information.

In some embodiments of the present application, wherein a state of the first UE is changed from an out-of-coverage state to an in-coverage state, and the transmitter 702 is further configured to report third SL positioning related information to the network, wherein the third SL positioning related information includes at least one of: UE information associated with at least one fourth UE, wherein the at least one fourth UE helps the first UE to acquire its position in the out-of-coverage state; SL positioning configuration associated with each of the at least one fourth UE; third assistance information.

In some embodiments of the present application, the transmitter is further configured to report fourth SL positioning related information used in a source cell to the network after a handover procedure to a target cell is completed, wherein the fourth SL positioning related information is generated based on the first SL positioning related information and includes at least one of: UE information associated with the at least one second UE; and SL positioning configuration associated with the each of at least one second UE; wherein the processor is further configured to keep using the fourth SL positioning related information before receiving a new positioning related information for the target cell from the network.

In some embodiments of the present application, the processor 706 is further configured to keep using the fourth SL positioning related information when at least one of the following timers is running: a first timer which is started when receiving an RRC reconfiguration message during the handover procedure; or a second timer which is started when initiating an RRC connection re-establishment procedure.

In some embodiments of the present application, the receiver 704 is further configured to receive new positioning related information for a target cell in a handover command from a source cell, and wherein the processor 706 is further configured to perform at least one of: using the new positioning related information during a handover procedure; or using the new positioning related information after a handover procedure to a target cell is completed.

In some embodiments of the present application, the processor 706 is further configured to use the new positioning related information when at least one of the following timers is running: a first timer which is started when receiving an RRC reconfiguration message during the handover procedure; or a second timer which is started when initiating an RRC connection re-establishment procedure.

According to some embodiments of the present application, the apparatus 700 may be a second UE. In some embodiments of the present application, the receiver 704 is configured to receive SL positioning configuration information from a first UE. The transmitter 702 is configured to transmit an indication indicating whether the SL positioning configuration information is rejected or accepted by the second UE.

In some embodiments of the present application, the receiver 704 is further configured to receive the SL positioning configuration information in a RRC message or in an upper layer signaling for SL positioning.

In some embodiments of the present application, the SL positioning configuration information includes a SL positioning configuration associated with the second UE or an index associated with the SL positioning configuration, and wherein the SL positioning configuration includes at least one of: information for transmitting or receiving SL-PRS; information for measuring the SL-PRS; or information for reporting a measurement result of the SL-PRS.

In some embodiments of the present application, the transmitter 702 is further configured to transmit assistance information to the first UE before receiving the SL positioning configuration information from the first UE.

In some embodiments of the present application, wherein the assistance information includes at least one of: at least one SL positioning configuration related to at least one third UE; PRS configuration; or SRS configuration.

In some embodiments of the present application, the transmitter 702 is further configured to transmit the SL positioning configuration information to the network in the case that the second UE is in-coverage of the network and determines to use the received SL positioning configuration information.

In some embodiments of the present application, the transmitter 702 is further configured to transmit the SL positioning configuration information to the network in the case that the second UE connects to the network.

In some embodiments of the present application, the transmitter 702 is further configured to report the SL positioning configuration information to the network after a handover procedure to a target cell is completed.

According to some embodiments of the present application, the apparatus 700 may be a network. In some embodiments of the present application, a receiver 704 is configured to receive assistance information from a first UE, wherein the assistance information includes UE information associated with at least one second UE, and wherein the at least one second UE helps the first UE to acquire its position. The transmitter 702 is configured to transmit SL positioning related information to the first UE.

In some embodiments of the present application, the assistance information further includes at least one of: location service requirement(s) associated with the first UE; configuration parameter(s) requested by the first UE from the network; or schedule location time of the first UE.

In some embodiments of the present application, the at least one second UE is determined by the first UE, and the UE information includes at least one of: an identification of each of the at least one second UE; the number of second UE(s); a status of each of the at least one second UE; serving cell information of each of the at least one second UE; UE capability associated with SL positioning of each of the at least one second UE; or a candidate UE list including an index of each of the at least one second UE.

In some embodiments of the present application, the at least one second UE is determined by the network based on the UE information, and the UE information includes at least one of: a minimum number of second UEs helping the first UE to acquire its position; or a preferred UE type of each of the second UEs helping the first UE to acquire its position.

In some embodiments of the present application, the receiver 704 is configured to receive the assistance information via an LPP signaling or an RRC signaling.

In some embodiments of the present application, the SL positioning related information includes at least one mapping, and wherein each mapping is: a mapping between a SL positioning configuration and a corresponding sidelink destination ID; a mapping between a SL positioning configuration and a corresponding second UE of the at least one second UE; or a mapping between a SL positioning configuration and a corresponding SL positioning capability index.

In some embodiments of the present application, the SL positioning configuration includes at least one of: information for transmitting or receiving SL-PRS; information for measuring the SL-PRS; or information for reporting a measurement result of the SL-PRS.

In some embodiments of the present application, the transmitter 702 is configured to transmit the SL positioning related information via an LPP signaling or an RRC signaling.

In some embodiments of the present application, the transmitter 702 is further configured to perform at least one of: transmitting the SL positioning related information in a handover request of a handover procedure to target cell of the first UE; or transmitting an indication in the handover request to the target cell, wherein the indication indicates the target cell that the SL positioning related information is kept being used by the first UE during the handover procedure until the first UE connects to the target cell and acquires new SL positioning related information from target cell.

In some embodiments of the present application, the transmitter 702 is further configured to transmit SL positioning related information obtained from the target cell to a LMF after deciding to perform a handover execution.

In some embodiments of the present application, the apparatus 700 may further include at least one non-transitory computer-readable medium. In some embodiments of the present disclosure, the non-transitory computer-readable medium may have stored thereon computer-executable instructions to cause the processor 706 to implement any of the methods as described above. For example, the computer-executable instructions, when executed, may cause the processor 706 to interact with the transmitter 702 and/or the receiver 704, so as to perform operations of the methods, e.g., as described with respect to FIGS. 4-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for SL positioning, including a processor and a memory. Computer programmable instructions for implementing a method for SL positioning are stored in the memory, and the processor is configured to perform the computer programmable instructions to implement the method for SL positioning. The method for SL positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A first user equipment (UE) for wireless communication, comprising:
at least one memory; and
at least one processor coupled with the at least one memory and configured to cause the first UE to:
transmit first assistance information to a network, wherein the first assistance information includes UE information associated with at least one second UE, and wherein the at least one second UE helps the first UE to acquire its position; and
receive first sidelink (SL) positioning related information from the network.

2. The first UE of claim 1, wherein the at least one second UE is determined by the first UE, and the UE information includes at least one of:
an identification of each of the at least one second UE;
a number of the at least one second UE;
a status of each of the at least one second UE;
serving cell information of each of the at least one second UE;
UE capability associated with SL positioning of each of the at least one second UE; or
a candidate UE list including an index of each of the at least one second UE.

3. The first UE of claim 1, wherein the at least one second UE is determined by the network based on the UE information, and the UE information includes at least one of:
a minimum number of second UEs helping the first UE to acquire its position; or
a preferred UE type of each of the second UEs helping the first UE to acquire its position.

4. The first UE of claim 1, wherein the at least one processor is further configured to cause the first UE to transmit the first assistance information to the network in response to at least one of the following conditions:
measurement quality for SL positioning meets a threshold; or
current SL positioning configuration cannot satisfy quality of service (QOS) requirements.

5. The first UE of claim 1, wherein the first SL positioning related information includes at least one mapping, and wherein each mapping is:
a mapping between a SL positioning configuration and a corresponding sidelink destination ID;
a mapping between a SL positioning configuration and a corresponding second UE of the at least one second UE; or
a mapping between a SL positioning configuration and a corresponding SL positioning capability index.

6. The first UE of claim 1, wherein the at least one processor is further configured to cause the first UE to transmit SL positioning configuration information to a second UE of the at least second UE and receive an indication indicating whether the SL positioning configuration information is rejected or accepted by the second UE, wherein the SL positioning configuration information is generated based on the first SL positioning related information and includes a SL positioning configuration or an index associated with the SL positioning configuration.

7. The first UE of claim 1, wherein a state of the first UE is changed from an in-coverage state to an out-of-coverage state, and the at least one processor is further configured to cause the first UE to perform at least one of the following:
keeping using the first SL positioning related information until the first SL positioning related information becomes invalid;
acquiring second SL positioning related information in the out-of-coverage state and keeping using the first SL positioning related information in the in-coverage state until the second SL positioning related information is available, wherein the second SL positioning related information is acquired by pre-configuration information; or
using default SL positioning related information during a time period from the first SL positioning related information becomes invalid to the second SL positioning related information is available, wherein the default SL positioning related information is pre-defined.

8. The first UE of claim 7, wherein the pre-configuration information comprises at least one mapping, each mapping of the at least one mapping is one of:
a mapping between a SL positioning configuration and a corresponding accuracy requirement;
a mapping between a SL positioning configuration and a corresponding number of third UEs, wherein each of the third UE helps the first UE to acquire its position;
a mapping between a SL positioning configuration and a corresponding SL positioning method; and
a mapping between a SL positioning configuration and a corresponding QoS or a radio condition.

9. The first UE of claim 1, wherein a state of the first UE is changed from an out-of-coverage state to an in-coverage state, and the at least one processor is further configured to cause the first UE to:
report third SL positioning related information to the network, wherein the third SL positioning related information comprises at least one of:
UE information associated with at least one fourth UE, wherein the at least one fourth UE helps the first UE to acquire its position in the out-of-coverage state;
SL positioning configuration associated with each of the at least one fourth UE;
third assistance information.

10. The first UE of claim 1, wherein the at least one processor is further configured to cause the first UE to report fourth SL positioning related information used in a source cell to the network after a handover procedure to a target cell is completed, wherein the fourth SL positioning related information is generated based on the first SL positioning related information and comprises at least one of:
UE information associated with the at least one second UE; and
SL positioning configuration associated with the each of at least one second UE; and
keep using the fourth SL positioning related information before receiving a new positioning related information for the target cell from the network.

11. The first UE of claim 1, wherein the at least one processor is further configured to cause the first UE to receive new positioning related information for a target cell in a handover command from a source cell, and wherein the processor is further configured to perform at least one of:
using the new positioning related information during a handover procedure; or
using the new positioning related information after a handover procedure to a target cell is completed.

12. A second user equipment (UE) for wireless communication, comprising:
at least one memory; and
at least one processor coupled with the at least one memory and configured to cause the second UE to:
receive sidelink (SL) positioning configuration information from a first UE; and
transmit an indication indicating whether the SL positioning configuration information is rejected or accepted by the second UE.

13. The second UE of claim 12, wherein the at least one processor is further configured to cause the second UE to transmit the SL positioning configuration information to the network when the second UE is in-coverage of the network and determines to use the received SL positioning configuration information.

14. The second UE of claim 12, wherein the at least one processor is further configured to cause the second UE to transmit the SL positioning configuration information to the network when the second UE connects to the network.

15. The second UE of claim 12, wherein the at least one processor is further configured to cause the second UE to report the SL positioning configuration information to the network after a handover procedure to a target cell is completed.

16. A processor for wireless communication, comprising:
at least one controller coupled with at least one memory and configured to cause the processor to:
transmit first assistance information to a network, wherein the first assistance information includes UE information associated with at least one UE, and wherein the at least one UE helps the processor to acquire its position; and
receive first sidelink (SL) positioning related information from the network.

17. The processor of claim 16, wherein the at least one UE is determined by the processor, and the UE information includes at least one of:
an identification of each of the at least one UE;
a number of the at least one UE;
a status of each of the at least one UE;
serving cell information of each of the at least one UE;
UE capability associated with SL positioning of each of the at least one second UE; or
a candidate UE list including an index of each of the at least one UE.

18. The processor of claim 16, wherein the at least one UE is determined by the network based on the UE information, and the UE information includes at least one of:
a minimum number of UEs helping the processor to acquire its position; or
a preferred UE type of each of the UEs helping the processor to acquire its position.

19. A processor for wireless communication, comprising:
at least one controller coupled with at least one memory and configured to cause the processor to:
receive sidelink (SL) positioning configuration information from a UE; and
transmit an indication indicating whether the SL positioning configuration information is rejected or accepted by the processor.

20. The processor of claim 19, wherein the at least one controller is further configured to cause the processor to transmit the SL positioning configuration information to the network when the processor is in-coverage of the network and determines to use the received SL positioning configuration information.
